(19) United States
(12) Patent Application Publication
(10) Pub. No.: US 2004/0211841 A1
(43) Pub. Date: Oct. 28, 2004

(54) Signature recognition smart card

(76) Inventor: Renee C. Martin-kessler, East Windsor, NJ (US)

Correspondence Address: Renee C. Martin-Kessler, 5 Dover Lane, East Windsor, NJ, 08520, US

(21) Appl. No.: 09/677,298

(22) Filed: Apr. 19, 2001

Related U.S. Application Data
(60) Provisional application No. 60/177,798, filed on Jan. 24, 2000.

(51) Int. Cl. G06K 19/06

(52) U.S. Cl. 235/492

(57) ABSTRACT

A smart credit card programmed to recognize a single signature for any applicable activities. Using the information in U.S. Pat. No. 5,9911,442 (Yamada) Dec. 23, 1999 and U.S. Pat. No. 6,009,082 (Caswell) Dec. 29, 1999 on pattern recognition and beginning with U.S. Pat. No. 3,962,679 (Engebrecht) on speed recognition in the handwriting, additional programming for four other parts of the writing will be utilized.

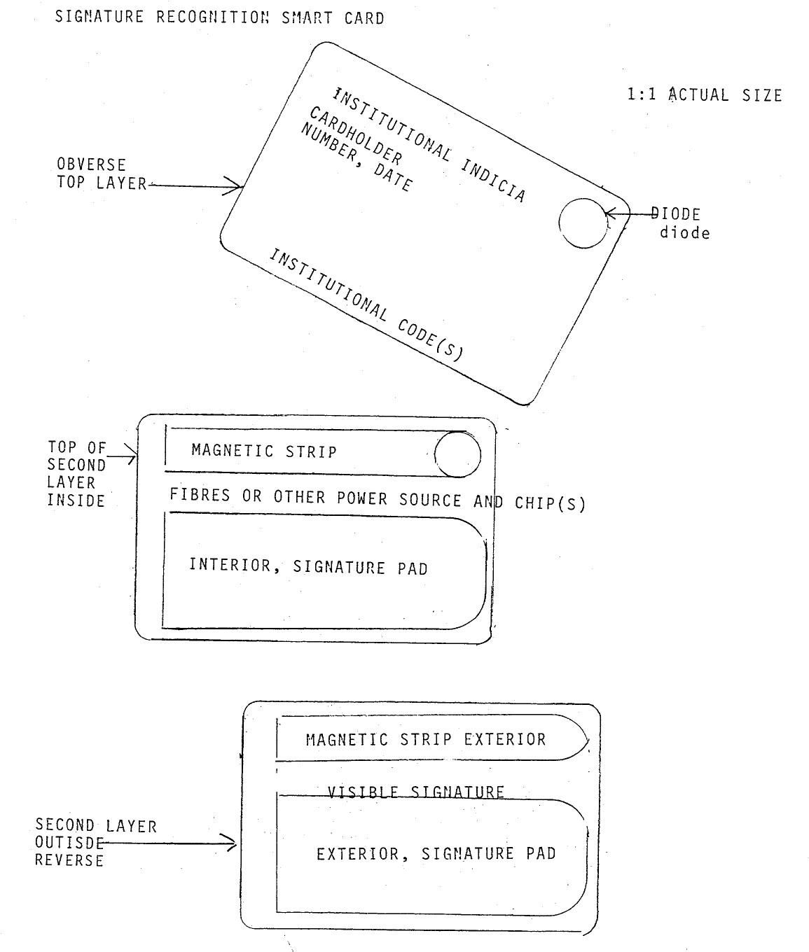

Obverse (Front)

A: Two layers

B: Front (Obverse)

C: Bank (Reverse)

D. Diode

E: Institutional (Bank) Identification Logo

F: Name, account number of holder

Interior:

G: Diode

H: Miniature Power Source

I: Miniature information safe(s)

J: Magnetic strip interior

K: Signature pad membrane

Back Exterior: (Reverse)

L: Magnetic strip exterior

M: Visible signature

N: Signature pad exterior.

### DEVICE

Signature Recognition Smart Card

### Purpose

Employing five parts of the writing as a basis for handwriting (signature) identification, and pattern recognition program U.S. Pat. No. 5,991,442 (Yamada) Nov. 23, 1999 and pattern recognition program U.S. Pat. No. 6,009,082 (Caswell) Dec. 28, 1999, this card will prevent misidentification of the legal owner of the card or unauthorized admittance to secure locations. Uses of the card include, but is not limited to:

1: Identify the rightful owner of the card.

2: Prevent illegal use of the true owner's rights.

3: Provide a mechanism for sub-rosa communication.

4: Give the true owner of the card free access to private transactions.

5: Prevent fraudulent use of the card for purchases, as well as business, commercial and other transactions and other activities normally utilizing credit cards at present and in the future.

6: Loss of the card will protect the owner from unauthorized use of the card's privileges.

7: Allow access to secure data and/or information via modem.

8: The pad and program may be utilized for other unique admission situations.

### CONSTRUCTION

A double thickness plastic or other medium card, approximately 3⅝″×2″×1/32″ which will support a sensitive strip designed to accept a specific signature.

A miniature energy source such as, but not limited to: a micro chip, lithium battery, synthetic DNA fiber, fibre optics or other miniature mechanism is installed between the top and bottom surfaces of the card.

A sensitive pad is programmed to accept only the signature of the legal owner of the card. One corner of the card contains an embedded diode which is no higher than the surface of the card.

Obverse (top) of the card contains logo of the issuing company with the name, card number, issuing and final permissible date. Reverse (bottom) shows proprietary information and a magnetic strip. The strip enables the establishment wishing to identify the user to simultaneously contact the central authorization bureau and trigger the enabling mechanism. A ⅞″×3″ sensitive strip will accept the signature of the user after it has been triggered by the act of swiping the card in the magnetic receptacle. If the signature has been authorized, the diode will light.

### Program

The program will recognize the authentic signature utilizing a combination of size of the individual's writing, pressure, speed, proportion, pen lifts and spacing taking the normal scope of variation into the matrix using current and future data storage methods.

### Illustration

The owner will hand the card to the clerk to complete the exchange. The clerk will request the user to sign his or her name onto the built-in magnetic strip on the back.

The diode will illuminate and acknowledge the true owner.

OR

The authorized individual will gain admittance to secure spaces by use of this card. A receptacle in the wall next to the locked site will accept the card, utilize the information on the magnetic strip and activates the signature pad. Recognition is signaled by the diode lighting and/or the door unlocking. If the signature is not accepted, the transaction is denied or the door remains locked.

OR

An individual in a remote location will utilize a pad connected to a computer at his or her location. The signature will be recognized by the digitally encoded signature by the receiving computer and admit the writer to sensitive information.

OR

Any other situation which will accept use of the card and programmed receptacle.

### Preparation

Several (twelve or more) signatures would be obtained on application for the card. As the writer changes his or her signature over time, the information on the chip will change accordingly, taking the last six to twelve signatures as the standard. The program will be set up to recognize attempts at forgery. If the writer utilizes more than one signature style, each would be embedded in the chip.

I claim:

1. A regulation sized credit card in two layers comprising a miniature device which will recognize only an authorized signature

2. The card carries a sensitive pad as well as a magnetic strip on the reverse (2^{nd} layer back) which will trigger the recognition mechanism.

3. The magnetic strip on the reverse layer of the card will
A: activate the recognition program as is the current use
B: alert the credit bureau of an impending transaction as is currently done

4. The card contains a microchip embedded between the two layers programmed to recognize the authorized signature at he time of writing on the sensitive strip and a miniature energy source.

5. The program will recognize the authorized signature utilizing five criteria only.

6. The transaction will be completed at the time of writing when a miniature light signals the correct signature
